(19) United States
(12) Patent Application Publication
(10) Pub. No.: US 2008/0296268 A1
(43) Pub. Date: Dec. 4, 2008

(54) Plasma generator and workpiece processing apparatus using the same

(75) Inventors: Masaaki Mike, Wakayama-shi (JP); Hirofumi Mankawa, Wakayama-shi (JP); Shigeru Masuda, Wakayama-shi (JP); Hirofumi Hayashi, Wakayama-shi (JP)

Correspondence Address: JORDAN AND HAMBURG LLP, 122 EAST 42ND STREET, SUITE 4000, NEW YORK, NY, 10168, US

(73) Assignee: NORITSU KOKI CO., LTD., Wakayama-shi (JP)

(21) Appl. No.: 12/154,384

(22) Filed: May 22, 2008

(30) Foreign Application Priority Data
Jun. 1, 2007 (JP) 2007-146856

(51) Int. Cl. H05H 1/34

(52) U.S. Cl. 219/121.5; 219/121.36

(57) ABSTRACT

Disclosed are a plasma generator and a workpiece processing apparatus, wherein an adapter 38 is attached to a distal end of each of a plurality of plasma generation nozzles 31 to convert a spot-shaped spout port of the plasma generation nozzle 31 to a lengthwise sport port 387, and a cover member 93 is provided to cover the plasma generation nozzles 31 so as to allow a narrow space to be defined between the cover member 93 and a workpiece, whereby plasma spouted from the spout port 387 is retained in the space in such a manner as to hit against and rebound from the workpiece into the space. This makes it possible to subject a workpiece having a relatively large surface area to plasma exposure in a uniform manner, while suppressing cooling of plasma in the space to allow the plasma to survive for a relatively long period of time (reduce a plasma disappearance rate) so as to provide enhanced efficiency of plasma exposure.

### BACKGROUND OF THE INVENTION

1. Field of the Invention

The present invention relates to a plasma generator designed to emit plasma toward a target object (workpiece), such as a substrate, so as to carry out cleaning, modification or other processing of a surface of the target object. The present invention also relates to a workpiece processing apparatus using the plasma generator.

2. Description of the Related Art

There has been known a workpiece processing apparatus designed to expose a target object (workpiece), such as a semiconductor substrate, to plasma so as to carry out a processing of a surface of the workpiece, such as removal of organic contaminants on the surface, modification of the surface, etching of the surface, or formation or removal of a thin film on the surface. For example, JP 2003-197397A (Publication 1) discloses a plasma processing apparatus using a plasma generation nozzle including an inner electrode and an outer electrode which are disposed in concentric relation to each other, wherein a high-frequency pulsed electric field is applied between the inner and outer electrodes so as to induce a glow discharge therebetween without an arc discharge, to generate plasma. With a view to obtaining high-density plasma under atmospheric pressures, this apparatus is designed to allow a processing gas from a gas supply source to be directed from a base end to a free end of the nozzle while being swirled in a space defined between the inner and outer electrodes, so as to produce high-density plasma and emit the plasma from the free end toward a workpiece.

Although the plasma generation nozzle disclosed in the Publication 1 has a configuration suitable for plasma generation, i.e., a configuration capable of generating high-density plasma under atmospheric pressures, the configuration is unsuitable for processing a workpiece having a relatively large surface area or processing a plurality of workpieces all together. Specifically, this plasma generation nozzle is generally formed in a cylindrical shape, wherein a spout port has a point or spot shape. Thus, there is a problem of being unable to subject a large-surface area workpiece or a group of workpieces to plasma exposure using a planar-shaped plasma stream.

From this point of view, JP 2004-006211A (Publication 2) discloses a plasma processing apparatus comprising two strip-shaped electrodes disposed in parallel relation to each other to serve, respectively, as an electric field-applying electrode and a ground electrode, wherein a processing gas is supplied into a plasma generation space defined by surrounding lateral sides of the electrodes, to generate a plasmatized processing gas, and the plasmatized processing gas is emitted from a slit-shaped spout port formed longitudinally in the ground electrode, toward a workpiece. In the apparatus disclosed in the Publication 2, the plasma is emitted from the slit-shaped spout port to enable plasma exposure using a line-shaped plasma stream. Although the apparatus disclosed in the Publication 2 has a potential to allow the plasmatized processing gas to be emitted relatively uniformly in a line pattern, the glow discharge device based on the parallel flat-plate electrodes involves problems about a need for a high discharge voltage, an increase in cost, and instability of discharge characteristics. Moreover, the glow discharge device is highly likely to locally induce an arc discharge. Thus, it is necessary to coat at least one of the electrodes with a dielectric material so as to suppress the occurrence of arc discharge, and thereby the discharge voltage has to be further increased. In terms of plasma generation, it can be said that the apparatus disclosed in the Publication 1 is superior to the apparatus disclosed in the Publication 2.

### SUMMARY OF THE INVENTION

It is an object of the present invention to provide a plasma generator capable of subjecting a target object having a relatively large surface area to plasma exposure in a uniform manner, even using a plasma generation nozzle having a spot-shaped spout port, and a workpiece processing apparatus using the plasma generator.

In order to achieve the above object, the present invention provides a plasma generator which comprises a plasma generation nozzle adapted to spout a plasma from a spout port thereof, and a cover member having a continuous surface which is disposed around the spout port of the plasma generation nozzle, and formed to have an area greater than that of a distal end surface of the plasma generation nozzle.

That is, the present invention is directed to a plasma generator usable for a processing of a target object, such as a surface modification of a substrate, wherein the plasma generation nozzle is formed in a configuration suitable for plasma generation, for example, in a structure adapted to induce a glow discharge between inner and outer electrodes disposed in concentric relation to each other so as to generate a plasma, and supply a processing gas between the inner and outer electrodes so as to emit a plasmatized gas from a ring-shaped spout port, and wherein the plasma generation nozzle is provided with the cover member at a distal end thereof to suppress scattering of the plasma by the cover member. Specifically, the cover member is prepared by forming, in a plate-shaped member, an opening which allows the spout port of the plasma generation nozzle to be uncovered. Then, the cover member is attached to cover the plasma generation nozzle formed, for example, in a cylindrical shape, so that a continuous surface, such as a flat or curved continuous surface, having an area greater than that of the distal end surface of the plasma generation nozzle is provided around the spout port of the plasma generation nozzle.

Thus, a narrow space is defined between the cover member and the target object, and plasma spouted from the spout port can be retained in the space in such a manner as to hit against and rebound from the target object into the space. This makes it possible to subject a target object having a relatively large surface area to plasma exposure in a uniform manner, even using a low-cost, easily-controlled and small-diameter plasma generation nozzle having a spot-shaped spout port. In addition, the narrow space can suppress cooling of plasma to allow the plasma to survive for a relatively long period of time (reduce a plasma disappearance rate) so as to provide enhanced efficiency of plasma exposure.

Therefore, the plasma generator of the present invention makes it possible to achieve a workpiece processing apparatus capable of subjecting a target object having a relatively large surface area to plasma exposure in a uniform manner, even using a low-cost, easily-controlled and small-diameter plasma generation nozzle having a spot-shaped spout port.

These and other objects, features and advantages of the invention will become more apparent upon reading the following detailed description along with the accompanying drawings.

### BRIEF DESCRIPTION OF THE DRAWINGS

FIG. 1 is a perspective view showing a general structure of a workpiece processing apparatus according to one embodiment of the present invention.

FIG. 2 is a perspective view showing a plasma generation unit, when viewed from a direction different from that in FIG. 1.

FIG. 3 is a partially cut-out side view showing the workpiece processing apparatus.

FIG. 4 is an enlarged sectional view showing a plasma generation nozzle and a vicinity thereof, taken along a plane orthogonal to an axis of a waveguide.

FIG. 5 is an exploded perspective view showing an adapter to be attached to a distal end of the plasma generation nozzle.

FIG. 6 is a sectional view schematically showing a function of the adapter.

FIG. 7 is an exploded perspective view of the plasma generation nozzle.

FIG. 8 is a fragmentary, enlarged and exploded perspective view of the plasma generation nozzle, when viewed from an angle different from that in FIG. 7.

FIGS. 9A and 9B are sectional views for explaining a function of a resilient member illustrated in FIGS. 7 and 8.

FIG. 10 is an enlarged and exploded perspective view showing an inner electrode, a holding member for holding the inner electrode, and a structure around an access hole for inserting them into the waveguide therethrough.

FIG. 11 is an exploded perspective view for explaining a mounted state of a microwave generation device to the waveguide.

FIG. 12 is a perspective view showing another example of the cover member for covering the plasma generation nozzle.

### DESCRIPTION OF THE PREFERRED EMBODIMENTS

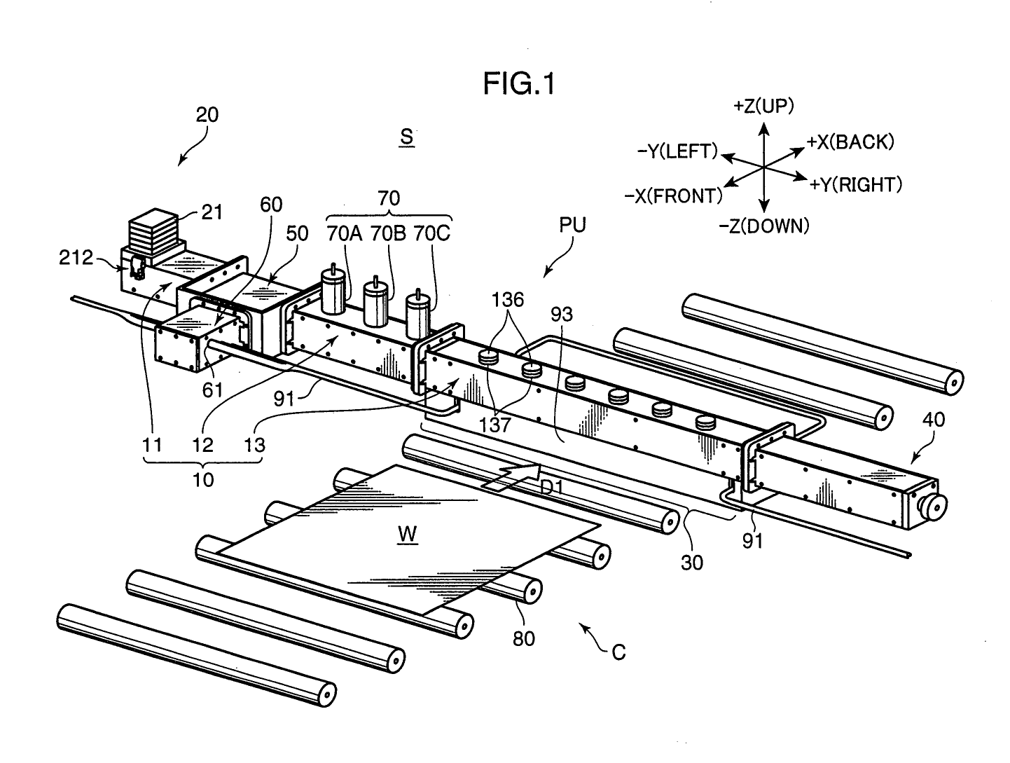

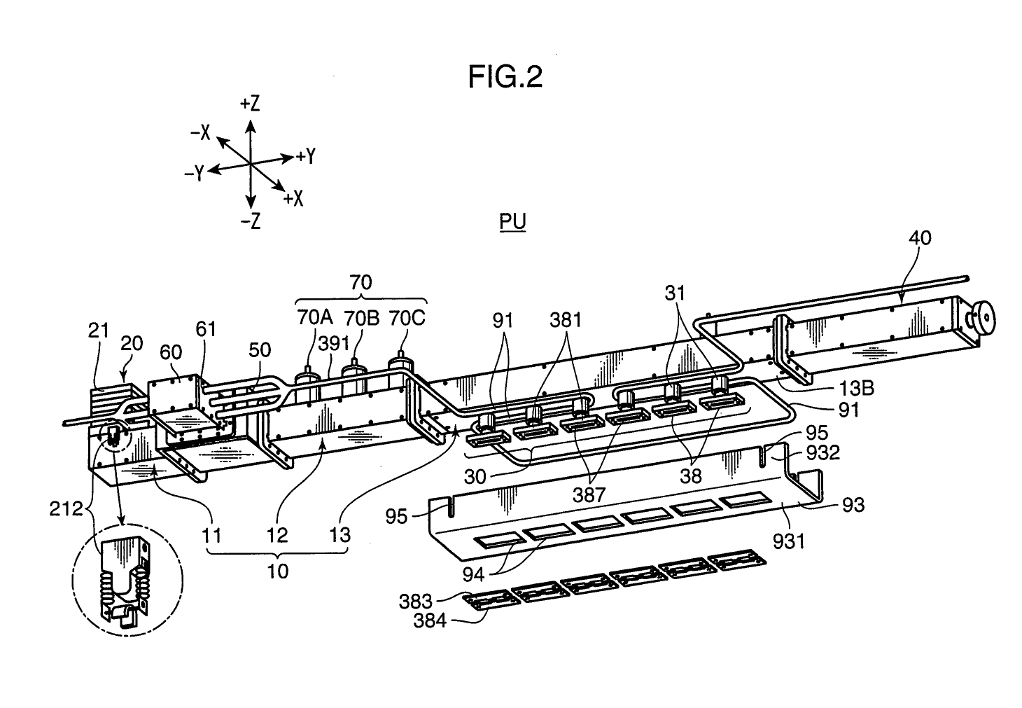

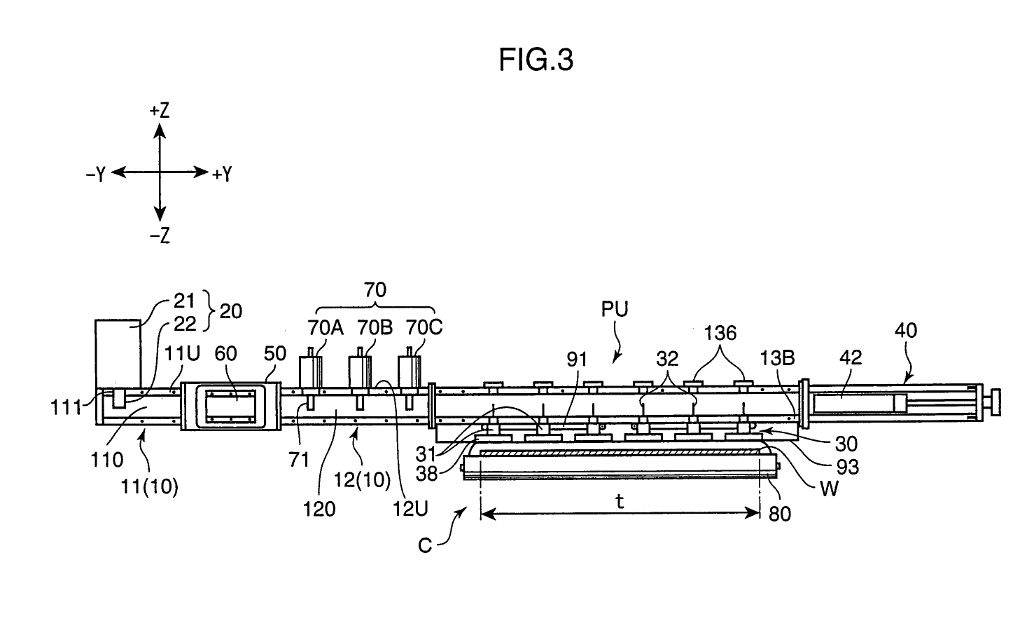

FIG. 1 is a perspective view showing a general structure of a workpiece processing apparatus S according to one embodiment of the present invention. This workpiece processing apparatus S comprises a plasma generation unit PU (plasma generator) adapted to generate plasma and emit the plasma toward a workpiece W which is a target object, and a carrying mechanism C (carrying means) adapted to carry the workpiece W along a predetermined route passing through an exposure zone to be exposed to the plasma. FIG. 2 is an exploded perspective view of the plasma generation unit PU when viewed from a direction different from that in FIG. 1, and FIG. 3 is a partially cut-out side view of the plasma generation unit PU. The following description will be made on an assumption that the X-X direction, the Y-Y direction and the Z-Z direction in FIGS. 1 to 3 are, respectively, a frontward/rearward (longitudinal) direction, a rightward/leftward (lateral) direction and an upward/downward (vertical) direction, and the −X direction, the +X direction, the −Y direction, the +Y direction, the −Z direction and the +Z direction in FIGS. 1 to 3 are, respectively, a frontward direction, a rearward direction, a leftward direction, a rightward direction, a downward direction and an upward direction.

The plasma generation unit PU is designed to generate plasma under ambient temperatures and atmospheric pressures through the use of a microwave. The plasma generation unit PU generally comprises: a waveguide 10 adapted to propagate a microwave; a microwave generation device 20 disposed at one end (left end) of the waveguide 10 and adapted to generate a microwave having a predetermined wavelength; a plasma generation section 30 provided to the waveguide 10; a sliding short 40 disposed at the other end (right end) of the waveguide 10 and adapted to reflect a microwave; a circulator 50 adapted to separate a reflected microwave from a microwave radiated into the waveguide 10 so as to prevent the reflected microwave from returning to the microwave generation device 20; a dummy load 60 adapted to absorb the reflected microwave separated by the circulator 50; and a stub tuner 70 adapted to perform impedance matching between the waveguide 10 and a plasma generation nozzle 31. The carrying mechanism C comprises a plurality of carrier rollers 80 adapted to be drivenly rotated by a drive mechanism (not shown). This embodiment will be described based on one example where a flat plate-shaped workpiece W is carried by the carrying mechanism C.

The waveguide 10 is made of a non-magnetic metal, such as aluminum, and formed to have a sectionally-rectangular long tube shape. The waveguide 10 is designed to propagate a microwave generated by the microwave generation device 20, toward the plasma generation section 30 along a longitudinal direction of the waveguide 10. The waveguide 10 is formed as a connected body in which a plurality of divided waveguide pieces are connected together through respective flanges thereof. Specifically, a first waveguide piece 11 having the microwave generation device 20 mounted thereto, a second waveguide piece 12 having the stub tuner 70 assembled thereto, and a third waveguide piece 13 provided with the plasma generation section 30, are disposed in turn from the left end of the waveguide 10, and connected together to form the connected body. More specifically, the circulator 50 is interposed between the first waveguide piece 11 and the second waveguide piece 12, and the sliding short 40 is connected to a right end of the third waveguide piece 13.

Each of the first waveguide piece 11, the second waveguide piece 12 and the third waveguide piece 13 are formed in an angular tube shape by assembling four metal flat plates consisting of a top plate, a bottom plate and two side plates, together, and a flange plate is attached to each of opposite ends of the assembly. Instead of the waveguide formed by assembling a plurality of flat plates, a plurality of rectangular waveguide pieces or a non-split type waveguide may be formed directly by an extrusion process or a bending process of a plate-shaped member. Further, the material of the waveguide 10 is not limited to the non-magnetic metal, but the waveguide 10 may be made of any other suitable material having a waveguide function.

The microwave generation device 20 comprises a device body section 21 having a microwave generation source, such as a magnetron adapted to generate a microwave, for example, of 2.45 GHz, and a microwave-transmitting antenna 22 adapted to radiate a microwave generated by the device body section 21, to an internal space of the waveguide 10. In the plasma generation unit according to this embodiment, a continuously-variable type microwave generation device capable of outputting microwave energy, for example, of 1 W to 3 kW, is suitably used as the microwave generation device 20.

As shown in FIG. 3, the microwave generation device 20 is a type in which the microwave-transmitting antenna 22 protrudes from the device body section 21. The microwave generation device 20 is fixed to the first waveguide piece 11 in such a manner as to be placed on the first waveguide piece 11. Specifically, the device body section 21 is placed on a top plate 11U of the first waveguide piece 11, and fixed in such a manner that the microwave-transmitting antenna 22 protrudes into a waveguide space 110 inside the first waveguide piece 11, through a through-hole 111 formed in the top plate 11U. Based on this structure, a microwave, for example, of 2.45 GHz, radiated from the microwave-transmitting antenna 22, can be propagated through the waveguide 10 from one (left) end toward the other (right) end of the waveguide 10.

The plasma generation section 30 comprises a plurality (in this embodiment, six) of plasma generation nozzles 31 which are arranged in spaced-apart relation to each other along a microwave propagation direction (lateral direction), and mounted to a bottom plate 13B (i.e., a surface opposed to the workpiece W) of the third waveguide piece 13. The plasma generation section 30 (i.e., the array of six plasma generation nozzles 31) has a width (i.e., lateral width) approximately equal to a lateral size t (i.e., a size in a direction orthogonal to a carrying direction) of the flat plate-shaped workpiece W. This makes it possible to subject an entire surface of the workpiece W (opposed to the bottom plate 13B) to a plasma processing while carrying the workpiece W by the carrier rollers 80. Preferably, the plasma generation nozzles 31 are arranged at given intervals determined depending on a wavelength λ_{G} of a microwave to be propagated through the waveguide 10. For example, the plasma generation nozzles 31 may be arranged at ½ pitch or ¼ pitch of the wavelength λ_{G}. More specifically, when a microwave of 2.45 GHz is used, the wavelength λ_{G} is 230 mm. Thus, the plasma generation nozzles 31 may be arranged at a pitch of 115 mm (λ_{G}/2) or 57.5 mm (λ_{G}/4).

The sliding short 40 is provided as a means to optimize a coupling state in which a center conductive member 32 in each of the plasma generation nozzles 31 captures a microwave propagated through the waveguide 10. The sliding short 40 is connected to the right end of the third waveguide piece 13 to change a reflection position of the microwave so as to adjust a standing wave pattern. Thus, in case of utilizing no standing wave, a dummy load having a wave absorbing function is attached in place of the sliding short 40. This sliding short 40 is internally provided with a columnar-shaped reflection block 42, and adapted to slidingly move the reflection block 42 in the lateral direction so as to optimize a standing wave pattern in the internal space of the waveguide 10.

The circulator 50 is composed, for example, of a waveguide-type 3-port circulator incorporating a ferrite column. The circulator 50 is operable, when a microwave propagated toward the plasma generation section 30 is reflected and partly retuned toward the microwave generation device 20 without energy consumption by the plasma generation section 30, to direct the reflected microwave to the dummy load 60 without retuning it to the microwave generation device 20. The circulator 50 can prevent the microwave generation device 20 from being excessively heated by the reflected microwave.

The dummy load 60 is a water-cooled (or air-cooled) wave absorber adapted to absorb the reflected microwave and convert it to heat. The dummy load 60 is provided with a cooling-water passage 61 for allowing cooling water to pass therethrough so as to allow the heat converted from the reflected microwave to be transferred to the cooling water in a heat-exchanging manner.

The stub tuner 70 serves as a means to perform impedance matching between the waveguide 10 and each of the plasma generation nozzles 31. In this embodiment, the stub tuner 70 comprises three stub tuner units 70A to 70C which are attached to a top plate 12U of the second waveguide piece 12 in an in-line arrangement at predetermined intervals. Each of the three stub tuner units 70A to 70C has the same structure designed such that a stub 71 protruding into a waveguide space 120 of the second waveguide piece 12 as shown in FIG. 3 is vertically moved between a protruding position and a retracted position so as to maximize energy consumption by the center conductive members 32, i.e., minimize reflected microwave energy, to facilitate plasma ignition.

In the carrying mechanism C, the plurality of carrier rollers 80 is arranged along a predetermined carrying path. Each of the carrier rollers 80 is adapted to be driven by the drive mechanism (not shown) so as to carry the workpiece W through the plasma generation section 30. For example, the workpiece W may include a flat substrate, such as a plasma display panel or a semiconductor substrate, and a printed circuit board having electronic components mounted thereon. The workpiece may further include a non-flat part and a non-flat assembly. In this case, instead of the carrier rollers, another type of carrying mechanism, such as a belt conveyer, may be employed.

An adapter 38 is attached to a distal end of each of the plasma generation nozzles 31.

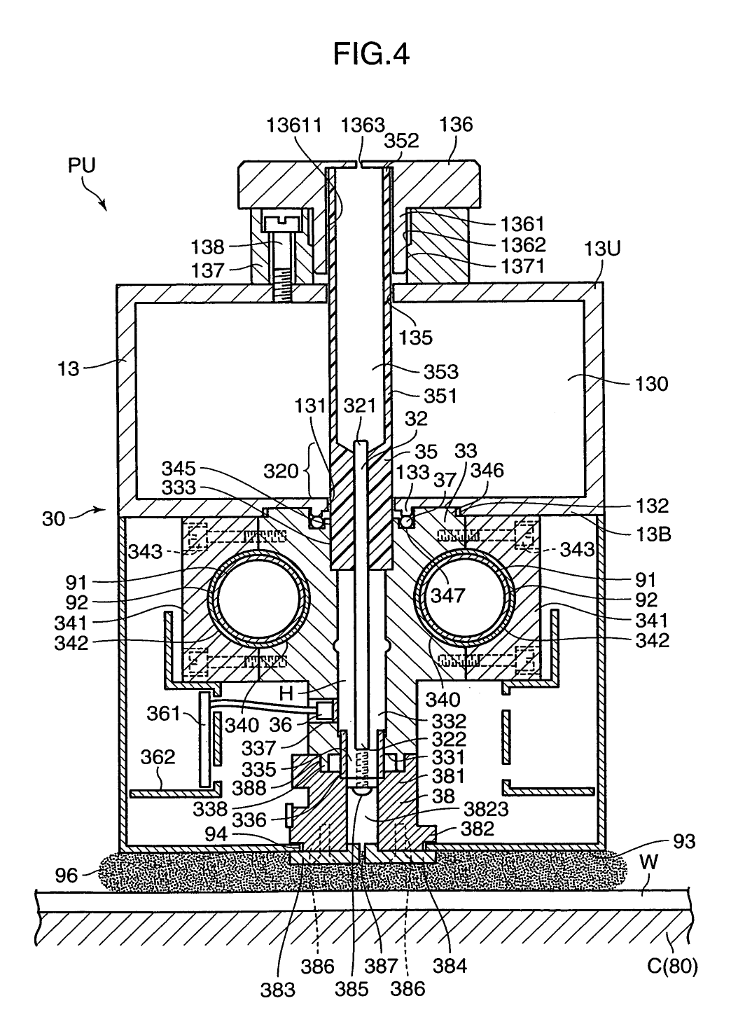

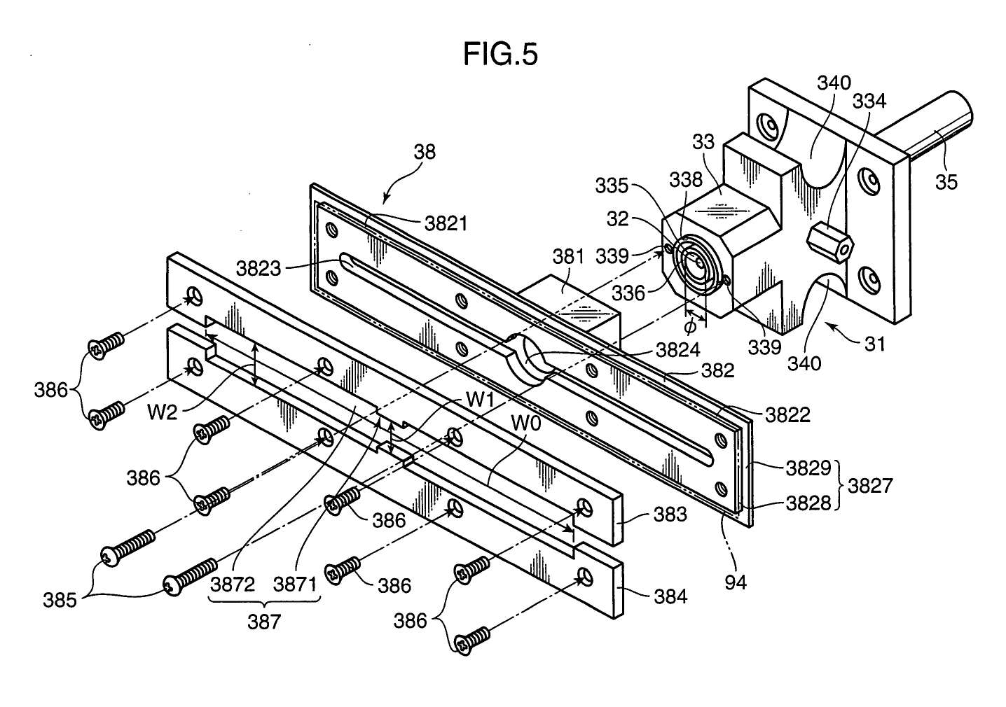

FIG. 4 is an enlarged sectional view of the plasma generation nozzle 31 and a vicinity thereof, taken along a plane orthogonal to an axis of the waveguide 10, and FIG. 5 is an exploded perspective view of the adapter 38. Each of the plasma generation nozzles 31 comprises the center conductive member 32 (serving as an inner electrode), a nozzle body 33 (serving as an outer electrode), a holding member 35, and a light sensor (i.e., photodetector) 36.

The center conductive member 32 is made of a highly electrically conductive metal, such as copper, aluminum or brass, and formed as a rod-shaped member having a diameter φ of about 1 to 5 mm. The center conductive member 32 is disposed vertically to have an upper end 321 which penetrates through the bottom plate 13B of the third waveguide piece 13 and protrudes into a waveguide space 130 of the third waveguide piece 13 by a predetermined length (this protruding portion will hereinafter be referred to as “receiving antenna portion 320”), and a lower end 322 which is in approximately flush relation with a distal end surface 331 of the nozzle body 33. The receiving antenna portion 320 is adapted to receive a microwave propagated through the waveguide 10 so as to supply microwave energy (microwave power) to the center conductive member 32. The center conductive member 32 is held along an axis of the nozzle body 33 by the holding member 35. The holding member 35 is made of a material transparent to microwave energy, preferably a heat-resistant resin material, such as Teflon (which is a registered trademark) or polypropylene, or a material having electrical insulating properties and a low-dielectric constant, such as a ceramic material.

The nozzle body 33 is made of a highly electrically conductive metal capable of establishing electrical connection with the third waveguide piece 13 (waveguide 10), and formed as a tubular-shaped member having a columnar space 332 which houses the center conductive member 32. The holding member 35 having a cylindrical shape is adapted to be fitted into a large-diameter receiving space 333 continuous with the columnar space 332 in a state after holding the center conductive member 32, so that the center conductive member 32 is disposed on an axis of the columnar space 332 in such a manner as to reliably define a predetermined ring-shaped space H (insulation gap) therearound. The ring-shaped space H is communicated with a pipe joint 334 through a communication hole (not shown) formed in the nozzle body 33, in such a manner that, when a processing gas is supplied from a processing-gas supply source through the pipe joint 334 and the communication hole, the processing gas is swirled (around the center conductive member 32) in the ring-shaped space H, and then spouted from a spout port 335.

The plasma generation nozzle 31 is constructed as above. Therefore, the nozzle body 33 and the third waveguide piece 13 (waveguide 10) are placed in a conduction state (i.e., to the same potential), whereas the center conductive member 32 is electrically insulated from the nozzle body 33 and the third waveguide piece 13 (waveguide 10), because the center conductive member 32 is supported by the electrically-insulating holding member 35. Thus, when a microwave is received by the receiving antenna portion 320 of the center conductive member 32 and thereby a microwave power is supplied to the center conductive member 32, an electric field concentration region will be formed around the lower end 322 of the center conductive member 32 and the distal end surface 331 of the center conductive member 32.

In the state, when an oxygen-based processing gas, such as oxygen gas or air, is supplied into the ring-shaped space H, the processing gas is excited by the microwave power, so that plasma (ionized gas) is generated around the lower end 322 of the center conductive member 32. This plasma is reactive plasma which has a gas temperature close to ambient temperatures while an electron temperature is several tens of thousands of degrees (the reactive plasma has an extremely high electron temperature indicated by electrons therein, as compared with a gas temperature indicated by neutrons therein), and is generated under atmospheric pressures.

According to a new gas flow supplied from the pipe joint 334, the processing gas plasmatized in the above manner is emitted from the distal end surface 331 of the nozzle body 33 in the form of a plume. This plume includes radicals. For example, if an oxygen-based gas is used as the processing gas, oxygen radicals can be generated to form a plume having a function of decomposing/removing organic substances, a function of removing a resist film or the like. The plasma generation unit PU according to this embodiment includes the array of plasma generation nozzles 31. Thus, a line-shaped plume extending in the lateral direction can be generated.

As the processing gas, an inert gas, such as argon gas, or nitrogen gas, may be used for subjecting various types of substrates to surface cleaning or surface modification. Alternatively, a compound gas containing fluorine may be used for modifying a substrate surface to a water-repellant surface, and a compound gas containing a hydrophilic group may be used for modifying a substrate surface to a hydrophilic surface. Alternatively, a compound gas containing a metal element may be used for forming a metal thin film on a substrate.

A protective tube 336 made, for example, of glass, is fitted into the spout port 335 in order to prevent corrosion of the distal end surface 331 of the nozzle body 33 due to generated plasma. Further, a mounting hole 337 is formed to extend from an outer peripheral surface of the nozzle body 33 toward the ring-shaped space H, and the light sensor 36 is fitted into the mounting hole 337 to detect whether plasma is ignited.

The adapter 38 generally comprises an attaching portion 381 adapted to allow a ring-shaped guide protrusion (annular ring) 338 formed on the distal end surface 331 of the nozzle body 33 to be fitted thereinto, a plasma chamber body 382 extending from a base end (i.e., lower end) of the attaching portion 381 in a horizontal direction, and a pair of slit plates 383, 384 adapted to be coveringly attached to the plasma chamber body 382. The attaching portion 381 and the plasma chamber body 382 are integrally formed by machining or casting. Each of the slit plates 383, 384 is formed by machining or punching.

The attaching portion 381 is formed in an angular tube shape, and attached to the nozzle body 33 by fittingly receiving the ring-shaped guide protrusion 338 in a recess 388 formed in an upper end surface thereof, and screwing an attaching screw 385 into a screw hole 339 formed in the distal end surface 331 of nozzle body 33. The slit plates 383, 384 are attached to a bottom surface of the plasma chamber body 382 by a plurality of countersunk screws 382.

The plasma chamber body 382 comprises a pair of chamber body portions 3821, 3822 extending from the lower end of the attaching portion 381 in opposite directions away from each other, wherein a lengthwise concave groove 3823 concaved upwardly is formed across the chamber body portions 3821, 3822 in a communicated manner, and an approximately central region of the concave groove 3823 is formed as a large-diameter opening 3824 communicated with an internal space of the attaching portion 381 defined by an inner peripheral surface thereof.

The slit plates 383, 384 are fittingly attached onto the bottom surface of the plasma chamber body 382 formed with the concave groove 3823, in such a manner that a space surrounded by the slit plates 383, 384 and the chamber body portions 3821, 3822 is defined as a plasma chamber. Thus, a plasmatized gas emitted from the columnar space 332 (or ring-shaped space H) of the nozzle body 33 is introduced from the attaching portion 381 into the concave groove 3823 through the opening 3824, and emitted from a spout port 387 defined between the slit plates 383, 384, in a strip or line pattern. The spout port 387 has a width W0 which is sufficiently larger than that of a diameter φ of the columnar space 332 of the nozzle body 33. For example, when the diameter φ of the columnar space 332 is set at 5 mm, the width W0 of the spout 387 may be set at 70 mm.

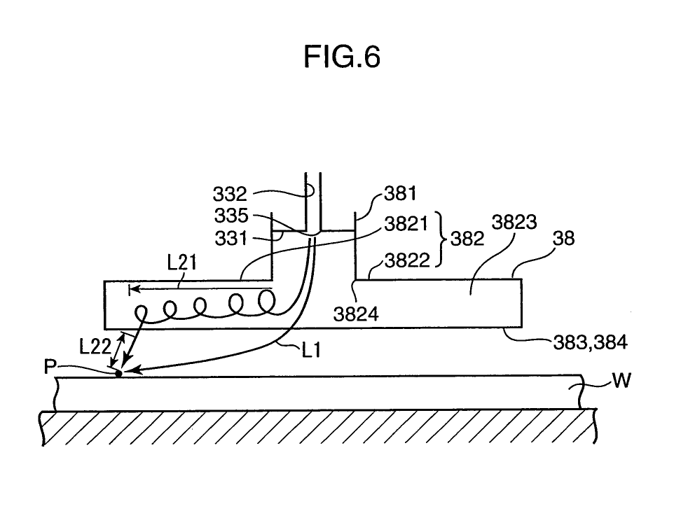

As shown in FIG. 6, in plasma exposure aiming at a desired exposure position P of a large-surface area workpiece W, using the plasma generation nozzle 31 adapted to induce a glow discharge between the center conductive member 32 (serving as the inner electrode) and the nozzle body 33 (serving as the outer electrode), which are disposed in concentric relation to each other, so as to generate a plasma, and supply a processing gas therebetween so as to emit a plasmatized gas from a ring-shaped spout port 335 under atmospheric pressures, if the plasma emitted from the spout port 335 directly reaches the exposure position P along a path indicated by the reference code L1, the plasma will be cooled in most of the path L1 to cause an increase in plasma disappearance rate. By contrast, in a state after attaching the adapter 38 adapted to convert the ring-shaped spout port 335 to the lengthwise spout port 387, even under a condition that a total path length to the exposure position P, the plasma is less likely to be cooled in a path L21 which passes inside the adapter 38 having high temperatures, and cooled only in a short path L22 where the plasma exits from the lengthwise spout port of the adapter 38 at a position just proximal to the exposure position P, and then actually reaches the exposure position P. Thus, even if the exposure position P is located far from the nozzle body 33, the plasma disappearance rate can be reduced. This makes it possible to subject a large-surface area workpiece W to plasma exposure in a uniform manner, even using a low-cost, easily-controlled and small-diameter plasma generation nozzle 31, without using an excessively large plasma generation nozzle.

As also illustrated in FIGS. 4 and 5, the lengthwise spout port 387 of the adapter 38 is formed to have an opening area which increases stepwise in an outward direction (in the embodiment illustrated in FIGS. 4 and 5, a region 3871 immediately beneath the opening 3824 which directly receives a plasma stream from the columnar space 332 (or ring-shaped space H) is formed to have a relatively small width W1, for example, of 0.3 mm, and the remaining region 3872 is formed to have a relatively large width W2, for example, of 0.5 mm).

The spout port 387 may be formed in a configuration where a lengthwise spout port has an opening width which continuously increases in the outward direction, or may be formed in a configuration where respective diameters of a plurality of spot openings arranged in a longitudinal direction of the adapter gradually increase in the outward direction, or may be formed in a configuration where the number of spot openings arranged in a longitudinal direction of the adapter gradually increases in the outward direction. That is, the spout port 387 may be formed to have an opening area which increases continuously or stepwise in the outward direction.

In the lengthwise spout port 387 formed in this configuration, a momentum (a spouting pressure, i.e., a flow rate (flow volume per unit time)) of a plasma stream is reduced, and a temperature of plasma is lowered. That is, the lengthwise spout port 387 is formed to have an opening area which increases stepwise or continuously, as described above, instead of being simply formed to have a constant width, so that an amount of plasma to be spouted increases toward an outward side of the lengthwise spout port 387. This makes it possible to subject a large-surface area workpiece W to plasma exposure in a more uniform manner. The slit plates 383, 384 may be integrally formed as a single piece. Further, the regions 3871, 3872 different in width may be defined in such a manner that only one of the slit plates has a stepped side surface (i.e., a side surface with steps, such as protrusions or cutouts), and the other slit plate has a flat side surface to be butted against the stepped side surface.

In the plasma generation unit PU having the above structure, a first noteworthy feature is that a cooling pipe 91 serving as a coolant passage is arranged between the plurality of plasma generation nozzles 31. In the embodiment illustrated in FIG. 2, the six plasma generation nozzles 31 is divided into two groups, and the cooling pipe 91 is arranged along each of the groups. In the embodiment illustrated in FIGS. 1 and 2, a coolant flowing out of a coolant circulation port 61 of the dummy load 60 is supplied to the cooling pipe 91. More specifically, a coolant from a coolant supply source, such as a pump (not shown), is circulated through the dummy load 60 and the plasma generation nozzles 31, and returned to the pump through a radiator (not shown). The cooling pipe 91 may be arranged along all the plasma generation nozzles 31 in block, or may be evenly arranged between respective ones of the plurality of plasma generation nozzles 31. In the embodiment illustrated in FIGS. 1 and 2, the cooling pipe 91 is arranged along both front and rear sides of the nozzle body 33. Alternatively, depending on a level of microwave power to be received by the plasma generation nozzle 31, or convenience in arrangement of a processing-gas supply pipe or an electric wire, the cooling pipe 91 may be arranged along only one of the front and rear sides of the nozzle body 33.

According to this feature, in cases where a plurality of plasma generation nozzles 31 are arranged side by side in a line, the plasma generation nozzles 31 to be heated to a high temperature due to plasma generation can be cooled without complexity in arrangement of a coolant passage extending from a pump or the like. In addition, a sensor, such as the light sensor 36, provided around each of the plasma generation nozzles 31, and an electronic circuit board 361 associated with the sensor, can be protected to suppress a malfunction of the sensor. The electronic circuit board 361 and an electric wire associated with the sensor and others are supported by a bracket 362 mounted to the plasma generation nozzle 31.

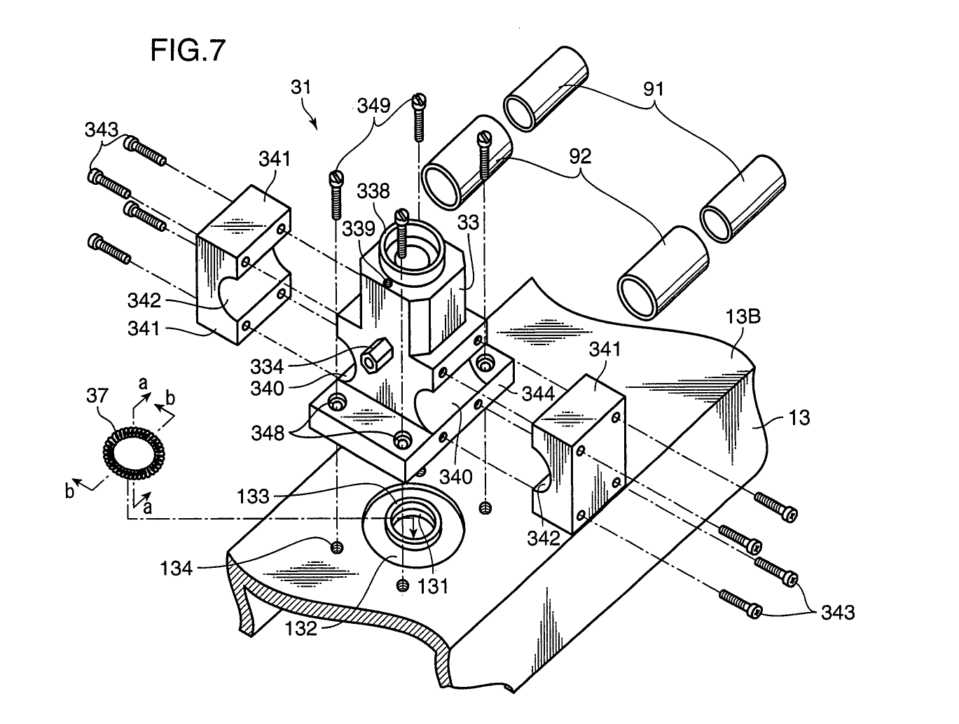

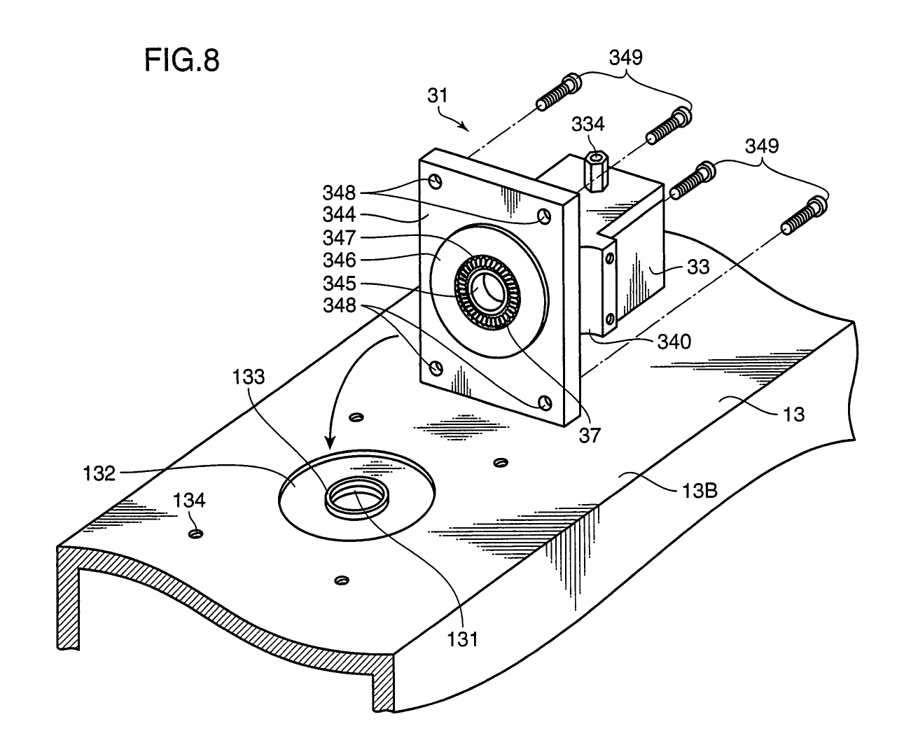

In the plasma generation nozzle 31 having a structure where the center conductive member 32 (serving as the inner electrode) is disposed in concentric relation to the nozzle body 33 (serving as the outer electrode), if the plasma generation nozzle 31 has the concentric structure without modification, the cooling pipe 91 will be simply brought into point contact (when the cooling pipe 91 has a circular tube shape) or into line contact (when the cooling pipe 91 has an angular tube shape) with the plasma generation nozzle 31. In the plasma generation unit PU according to this embodiment, as shown in FIGS. 7 and 8, an outer peripheral surface of the nozzle body 33 is partly cut off to form a concave portion 340 corresponding to the cooling pipe 91. FIG. 7 is an exploded perspective view of the plasma generation nozzle 31, and FIG. 8 is a fragmentary, enlarged and exploded perspective view of the plasma generation nozzle 31, when viewed from an angle different from that in FIG. 7 (The plasma generation nozzle 31 is simplistically shown in FIG. 2 for easy understanding.) Thus, the cooling pipe 91 can be fitted into the concave portion 340 to have an increased contact area between the cooling pipe 91 and the plasma generation nozzle 31. This makes it possible to obtain enhanced cooling efficiency.

Furthermore, in the plasma generation unit PU according to this embodiment, a resilient member 92 excellent in heat transfer is interposed between the concave portion 340 and the cooling pipe 91. This makes it possible to enhance heat transfer between the plasma generation nozzle 31 and the cooling pipe 91 so as to obtain more enhanced cooling efficiency. Particularly, when a horizontally-extending portion of the cooling pipe 91 is fixedly held by the respective plasma generation nozzles 31 arranged in spaced-apart relation to each other, as will be specifically described later, the cooling pipe 91 is bent at positions on both sides of the fixed portion by its own weight, and thereby a gap is likely to occur relative to the plasma generation nozzle 31. In this situation, the resilient member 92 interposed between the plasma generation nozzle 31 and the cooling pipe 91 can eliminate such a gap.

In the plasma generation unit PU according to this embodiment, the cooling pipe 91 is brought into close contact with the concave portion 340 by a retaining member 341. In the embodiment illustrated in FIG. 7, the retaining member 341 is formed with a concave portion 342 having an arc-shaped section identical to the concave portion 340, in the same manner as that in the nozzle body 33. Thus, the retaining member 341 can be fastened to the nozzle body 33 by a screw 343 to retain the cooling pipe 91 wrapped in the resilient member 92, between the concave portions 340, 342 in a close contact manner While the retaining member may have any suitable shape capable of pressing the cooling pipe 91 against the nozzle body 33, such as a plate shape, the retaining member 341 having the concave portion 342 adapted to come into close contact with an outer peripheral surface of the cooling pipe 91 allows heat of the nozzle body 33 to be transferred thereto once and then transferred to the cooling pipe 91, so that a contact surface of the nozzle body 33 relative to the cooling pipe 91 can be substantially increased to achieve more enhanced heat transfer (cooling efficiency). This makes it possible to more reliably perform temperature protection of components, such as the light sensor 36 which is composed of a photodiode or the like and easily affected by heat, and the electronic circuit board 361.

In the plasma generation unit PU according to this embodiment, if the retaining member 341 is fixedly screwed onto the third waveguide piece 13 during the operation of bringing the cooling pipe 91 into close contact with the nozzle body 33 using the retaining member 341, wobbling is likely to occur between the cooling pipe 91 and the concave portions 340, 342, due to thermal expansion of the waveguide 10 arising from microwave propagation, to cause deterioration in heat transfer. In contrast, the retaining member 341 fixedly screwed onto the nozzle body 33 can eliminate the above risk to enhance the heat transfer so as to obtain enhanced cooling efficiency. In addition, this structure has no adverse effect on a junction between the nozzle body 33 and the third waveguide piece 13.

Another noteworthy feature in the above plasma generation unit PU is that a resilient member 37 having an electrical conductive property is interposed between the junction between the nozzle body 33 and the third waveguide piece 13, as shown in FIGS. 7 and 8. Specifically, additionally referring to FIG. 4, a flat plate-shaped bracket 344 for attachment to the third waveguide piece 13 is fixed to a base end of the nozzle body 33 (serving as the outer electrode). The bracket 344 has an opening 345 formed in a central region thereof in such a manner as to be communicated with the receiving space 333 while allowing the center conductive member 32 held by the holding member 35, to be movably inserted thereinto. Further, the central region of the bracket 344 has a step-like raised portion 346 formed in order to prevent leakage of microwave, and position the nozzle body 33. The raised portion 346 has a ring-shaped concave groove 347 formed around the opening 345.

Correspondingly, the bottom plate 13B of the third waveguide piece 13 has an opening 131 formed in such a manner as to be communicated with the opening 345 while allowing the center conductive member 32 held by the holding member 35, to be movably inserted thereinto, and a concave portion 132 formed around the opening 131 correspondingly to the raised portion 346. The concave portion 132 has a ring-shaped protrusion (annular ring) 133 formed correspondingly to the concave groove 347 to have a height less than a depth of the concave groove 347.

Thus, when the plasma generation nozzle 31 is positioned in such a manner that the raised portion 346 is fitted into the concave portion 132 after the resilient member 37 is fitted into the concave groove 347, the ring-shaped protrusion 133 is also fitted into the concave groove 347. Then, a screw 349 penetrating through a screw hole 348 formed in an outer peripheral region of the bracket 344 is screwed in a screw hole 134 formed in the bottom plate 13B, so that the resilient member 37 is clamped between a distal end surface of the ring-shaped protrusion 133 and a bottom surface of the concave groove 347.

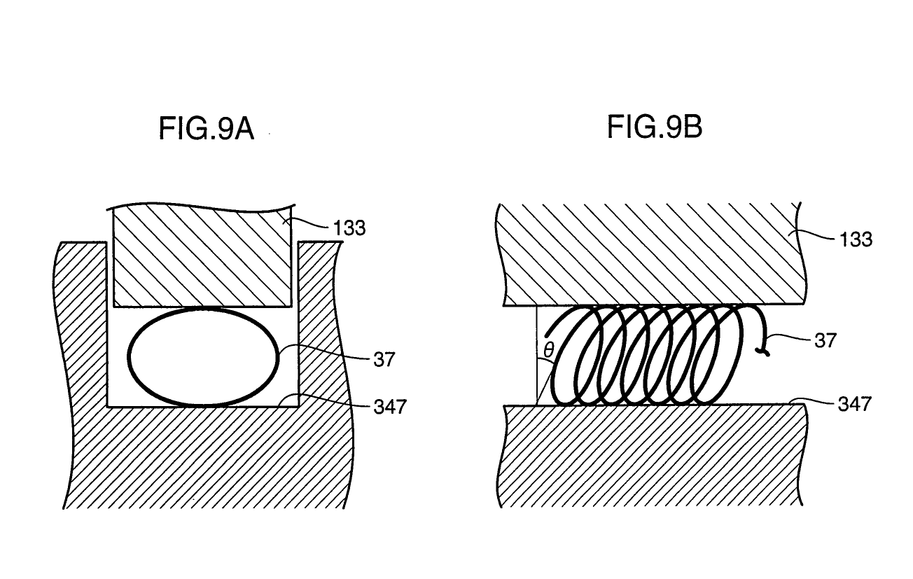

In the embodiment illustrated in FIGS. 7 and 8, the resilient member 37 comprises an O-ring formed of a ring-shaped coil spring having opposite ends connected together. In this case, when the screw 349 is gradually screwed in the screw hole 134, the resilient member 37 is elastically deformed (collapsed) in a radial direction thereof, as shown, for example, in FIG. 9A, or deformed in such a manner that a winding angle 0 of the coil spring is increased (i.e., the coil spring is inclined), as shown, for example, in FIG. 9B, or deformed in a combinational manner thereof. FIGS. 9A and 9B are sectional views taken along the line a-a and the line b-b in FIG. 7, respectively.

According to this feature, even in a longtime processing, or even if thermal expansion occurs during processing, or even if there is a tolerance in the waveguide 10 or the plasma generation nozzle 31, the resilient member 37 interposed between the waveguide 10 and the plasma generation nozzle 31 can stabilize an electrical contact (junction) therebetween. This makes it possible to allow a microwave power picked up by the center conductive member 32 (serving as the inner electrode of the plasma generation nozzle 31), to reliably flow to the nozzle body 33 so as to allow plasma to be stably generated, and suppress reflection of the microwave power at the junction so as to avoid plasma ignition in the internal space of the waveguide and melting of the junction. In addition, a variation in characteristics (plasma ignitability, etc.) between the plasma generation nozzles 31 can be suppressed.

In the case where the O-ring formed of a ring-shaped coil spring having opposite ends connected together, and hardly positioned due to its stretchability or deformability, is used as the resilient member 37, the O-ring can be readily positioned in advance of the operation of mounting the plasma generation nozzle 31 to the waveguide 10, by forming the concave groove 347 and the ring-shaped protrusion 133, and simply fitting the O-ring into the concave groove 347. The concave groove 347 and the ring-shaped protrusion 133 may be formed, respectively, in the bottom plate 13B and the nozzle body 33. However, in the structure where the plasma generation nozzle 31 is mounted below the waveguide 10, as shown in FIGS. 1 to 3, the concave groove 347 and the ring-shaped protrusion 133 are preferably formed, respectively, in the nozzle body 33 and the bottom plate 13B, as shown in FIGS. 7 and 8, to prevent drop-off of the O-ring. It is not essential to form the ring-shaped protrusion 133. Specifically, if the concave groove 347 has a depth enough to prevent drop-off of the O-ring due to deformation thereof, the O-ring may be deformed between a flat surface of the bottom plate 13B, and the bottom surface of the concave groove 347.

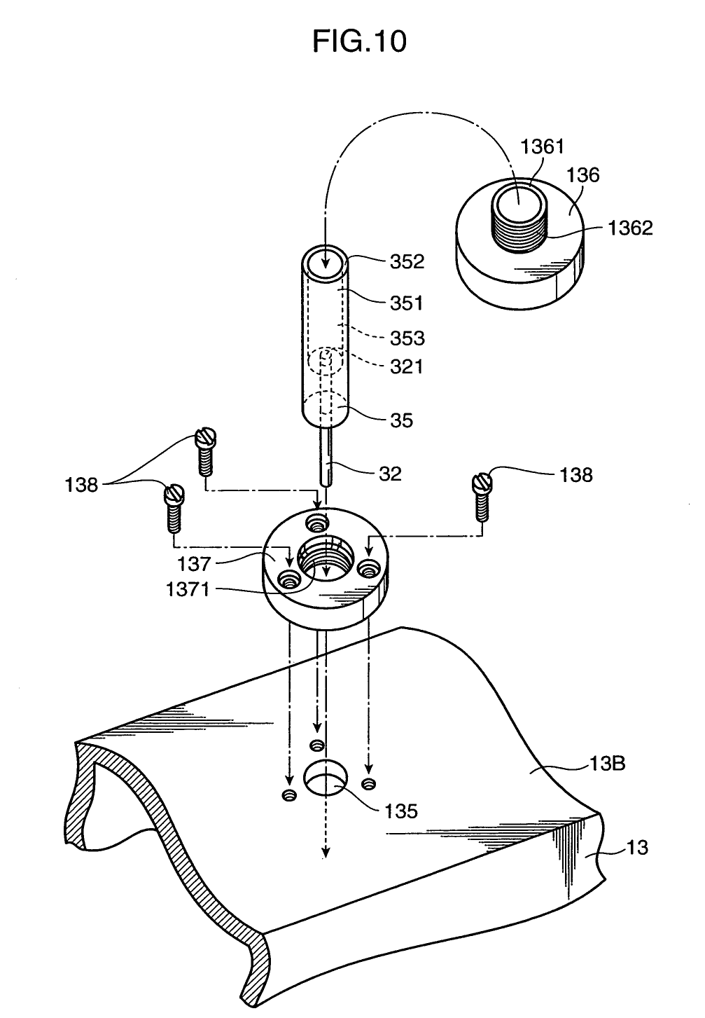

Yet another noteworthy feature in the above plasma generation unit PU is that the holding member 35 holding the center conductive member 32 (serving as the inner electrode) has a portion protruding into the inner space of the waveguide 10, wherein at least a part of the protruding portion of the holding member 35 is formed as a grip portion 351 which extends to a top plate 13U on an opposite side of the bottom plate 13B mounting thereto the nozzle body 33 (serving as the outer electrode), and the top plate 13U is formed with an access hole 135 for allowing the center conductive member 32 held by the holding member 35, to be movably inserted thereinto, as shown in FIGS. 4 and 10. FIG. 10 is an enlarged and exploded perspective view showing the holding member 35 and a structure around the access hole 135.

In the embodiment illustrated in FIGS. 4 and 10, the grip portion 351 is formed as a single piece together with the remaining portion of the holding member 35, using a material which has the same electrical insulating properties and low-dielectric constant as those of the remaining portion of the holding member 35. The grip portion 351 is formed in a tubular shape which has an internal space capable of receiving therein the center conductive member 32, and an end 352 to be pressed by a cap member 136 for closing the access hole 135. In order to allow the access hole 135 to be closed by the cap member 136, a mouth ring 137 corresponding to the cap member 136 is fixedly fastened to the top plate 13U by a screw 138, and a tube portion 1361 formed on a central region of the cap member 136 is inserted into a center hole of the mouth ring 137 in such a manner that an externally threaded region 1362 formed in an outer peripheral surface of the tube portion 1361 is engaged with an internally threaded region 1371 formed in an inner peripheral surface of the center hole of the mouth ring 137.

In an operation of setting the center conductive member 32, an operator grips the grip portion 351, and fits the holding member 35 into the receiving space 333 by movably inserting the holding member 35 and the center conductive member 32 into the center hole of the mouth ring 137 and the access hole 135. Then, the end 352 of the grip portion 351 is fitted into a receiving space 13611 defined inside the tube portion 1361, and the cap member 136 is screwed with the mouth ring 137. Through this operation, the holding member 35 is gradually pressed into the receiving space 333. In this manner, the center conductive member 32 (serving as the inner electrode) can be constantly set at a predetermined position to allow a glow discharge to be stably induced.

According to this feature, the access hole 135 can be opened to perform an operation of replacing the center conductive member 32 held by the holding member 35. Thus, the replacement operation can be performed in an extremely easy manner as compared with a replacement operation to be accessed from the side of the workpiece W, without a need for detaching the third waveguide piece 13 having the plasma generation nozzle 31 mounted thereto. In addition, an operator can replace the center conductive member 32 while gripping the grip portion 351 as an extension of the holding member 35, without touching or contacting the center conductive member 32 by his/her hand or a tool. This makes it to prevent scratching the center conductive member 32, and perform the replacement operation without using a specialized tool.

The grip portion 351 may be formed to extend slightly excessively. In this case, the center conductive member 32 can be pressed in a constant manner by the holding member 35, while absorbing an excessive length by bending of the tubular-shaped grip portion 351. This makes it possible to constantly set the center conductive member 32 at a predetermined position, as described above, without strictly managing a length of the grip portion 351. In the above structure, if the top plate 13U has a plate thickness enough to allow the internally threaded region 1371 to be formed in an inner peripheral surface of the access hole 35, and a wear of the internally threaded region 1371 to be caused by attachment/detachment of the cap member 136 is not significant, the mouth ring 137 may be omitted.

In the above structure, if the receiving antenna portion 320 of the center conductive member 32 is completely embedded in the grip portion 351, if plasma ignition is accidentally induced in the internal space of the waveguide 10, a material of the grip portion 351 in a vicinity of a base end (the upper end 321) of the center conductive member 32 causing the plasma ignition will be melted. In this embodiment, at least a part of the base end (the upper end 321) protrudes outside the grip portion 351 (in the embodiment illustrated in FIGS. 4 and 10, the upper end 321 is exposed (bared) to the internal space 353 of the tubular-shaped grip portion 351, and thereby the plasma ignition will be induced at the exposed upper end 321 so as to prevent melting of the grip portion 351.

As shown in FIG. 4, the screwed-type cap member 136 is formed with a vent hole 1363 which opens the internal space 353 of the tubular-shaped grip portion 351 to an outside of the cap member 136. Thus, even if the center conductive member 32 is heated to a high temperature in conjunction with receiving of a microwave and resulting plasma ignition, the vent hole 1363 can serve as a discharge hole capable of discharging air expanded due to the high temperature, to prevent an excessive increase in internal pressure of the tubular-shaped grip portion 351 so as to avoid deformation of the grip portion 351 and drop-off of the center conductive member 32 toward the workpiece W.

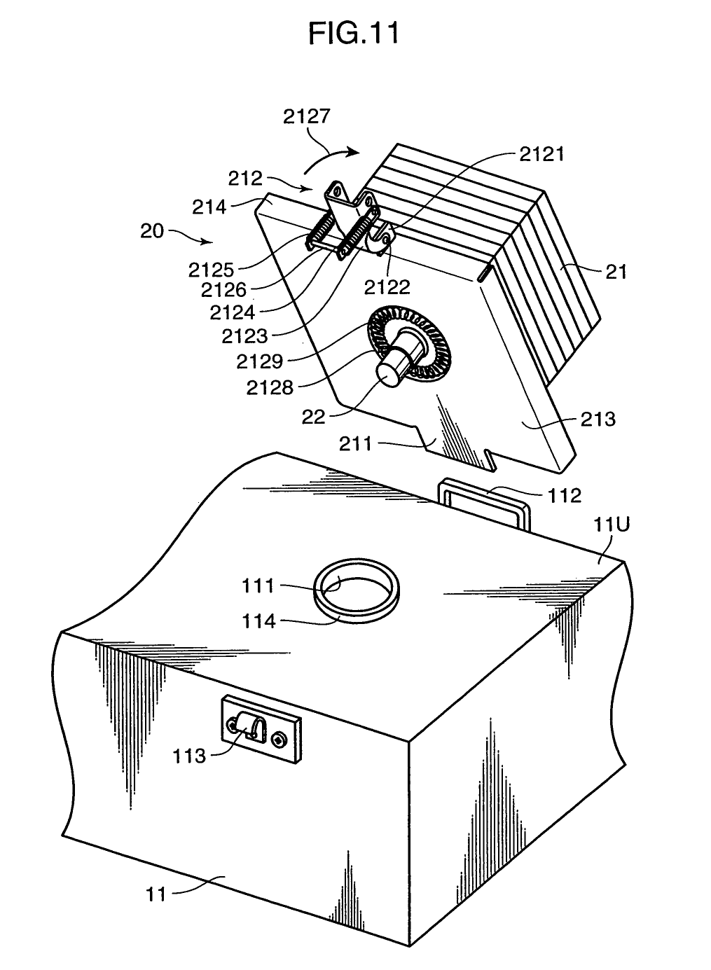

Still another noteworthy feature in the above plasma generation unit PU is that the microwave generation device 20 is detachably mounted to the top plate 11U of the first waveguide piece 11, using a hook 211 and a spring-type catch clip 212, as shown in FIG. 11. FIG. 11 is an exploded perspective view for explaining a mounted state of the microwave generation device 20 to the top plate 11U of the first waveguide piece 11.

Specifically, an engagement member 112 engageable with the hook 211 is fixed to a first one of opposed side surfaces of the first waveguide piece 11, and a hook 113 engageable with the spring-type catch clip 212 is fixed to the other side surface (i.e., second side surface) of the first waveguide piece 11. The engagement member 112 comprises a reverse U-shaped member. In a mounting operation, the microwave generation device 20 is set in an inclined posture, and the hook 211 extending from a bottom plate 213 of the device body section 21 is inserted into a gap defined between an upper edge of the reverse U-shaped engagement member 112 and the top plate 11U. Then, the microwave generation device 20 is released from the inclined posture in such a manner as to allow the microwave-transmitting antenna 22 to be fitted into the through-hole 111. Through this operation, the microwave generation device 20 is retained relative to the first side surface of the first waveguide piece 11.

The spring-type catch clip 212 comprises: a support member 2121 fixed to a side plate 214 of the device body section 21; a pin 2122 supported by the support member 2121 to extend in the lateral direction; a clip body 2123 swingably supported about the pin 2122; a pair of spring pieces 2124, 2125 each having a base end swingably attached to a corresponding one of right and left surfaces of a free end of the clip body 2123; and a lock pin 2126 bridged between respective distal ends of the spring pieces 2124, 2125.

Thus, after the hook 211 is engaged with the engagement member 112, and then the microwave generation device 20 is placed on the top plate 11U to allow the microwave-transmitting antenna 22 to protrude from the through-hole 111 into the waveguide space 110, the microwave generation device 20 can be retained relative to the second side surface of the first waveguide piece 11, by engaging the lock pin 2126 with the hook 113, and then swingingly moving the clip body 2123 in the arrowed direction 2127.

According to this feature, the microwave generation device 20 can be readily replaced (detached and attached) by selectively unfastening and fastening the spring-type catch clip 212, without using a tool. This makes it possible to reduce a maintenance time so as to carry out a stable plasma processing. In addition, the microwave generation device 20 is mounted to the top plate 11U while being pressed against the top plate 11U by a spring force generated from the spring pieces 2124, 2125 of the spring-type catch clip 212. This makes it possible to prevent the occurrence of wobbling in a junction therebetween due to thermal stress or the like so as to provide enhanced reliability for the mounting of the microwave generation device 20 to the first waveguide piece 11.

Further, the top plate 11U has a ring-shaped protrusion (annular ring) 114 formed around the through-hole 111, and the microwave generation device 20 has a ring-shaped concave groove 2128 formed in a position corresponding to the ring-shaped protrusion 114, wherein a resilient material 2129 having an electrical conductivity is laid in the concave groove 2128. Thus, even if slipping (displacement along a surface of the top plate 11U) or lift of the microwave generation device 20 occurs due to vibration, thermal stress or the like, the ring-shaped protrusion 114 fitted into the concave groove 2128 and brought into close contact with the resilient material 2129 can reliably block leakage of a microwave.

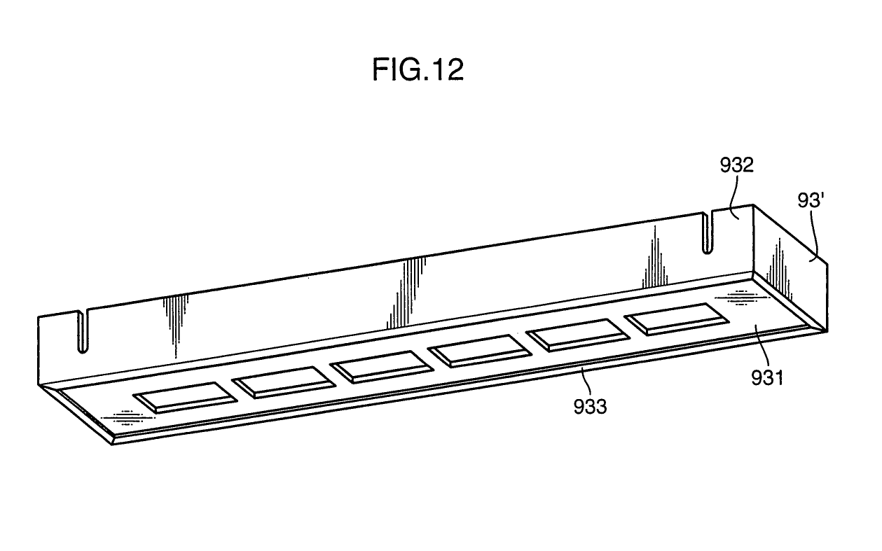

Yet still another noteworthy feature is that the above plasma generation unit PU is provided with a cover member 93 having a continuous surface which is disposed around the spout port 335 of the plasma generation nozzle 31, and formed to have an area greater than that of the distal end surface 331 of the plasma generation nozzle 31, as shown in FIGS. 1 to 4. As shown in FIG. 2, the cover member 93 has a bottom surface 931 formed with an opening 94 corresponding to the adapter 38, and opposed side surfaces 932 each formed with a slit 95 corresponding to the cooling pipe 91, or a gas pipe or electric wire (not shown). The bottom surface 931 of the cover member 93 is not limited to a flat shape as shown in FIG. 2, but may have a curved shape depending on a shape of the workpiece W. The point is that the cover member 93 has a continuous surface formed around the distal end surface 331 of the plasma generation nozzle 31. Further, as shown by a cover member 93′ in FIG. 12, a mound 933 rising in a spouting direction of plasma may be additionally formed along an outer peripheral edge of a bottom surface 931.

As used in this specification, the term “continuous surface” means a region of the bottom surface 931 of the cover member 93 (FIG. 2) or the cover member 93′ (FIG. 12), except the opening 94, and includes respective bottom surfaces of the slit plates 383, 384.

As shown in FIG. 5, correspondingly to the cover member 93 (93′), a step 3827 is formed in an outer peripheral edge of the bottom surface of the plasma chamber body 382 of the adapter 38. A raised portion 3828 of the plasma chamber body 382 surrounded by the step 3827 is fitted into the opening 94, and a portion of the cover member 93 (93′) defining a peripheral edge of the opening 94 is clamped and held by a flange 3829 of the plasma chamber body 382 and the slit plates 383, 384.

In the plasma generation unit PU provided with the cover member 93 (93′), as shown in FIG. 4, a narrow space 96 is defined between the cover member 93 (93′) and the workpiece W. Thus, plasma spouted from the spout port 335 can be retained in the space 96 in such a manner as to hit against and rebound from the workpiece W into the space 96. This makes it possible to subject a large-surface area work piece W to plasma exposure in a uniform manner, even using the low-cost, easily-controlled and small-diameter plasma generation nozzle 31 having the spot-shaped spout port 335. In addition, the narrow space 96 can suppress cooling of plasma to allow the plasma to survive for a relatively long period of time (reduce a plasma disappearance rate) so as to provide enhanced efficiency of plasma exposure. Particularly, the cover member 93′ having the mound 933 formed in the outer peripheral edge of the bottom surface 931 can further suppress scattering of the plasma. Further, in cases where the plasma generation nozzle 31 is provided in a plural number, the continuous surface of the cover member 93 (93′) is formed and arranged to extend over respective distal end surfaces of the plural number of plasma generation nozzles 31. Thus, plasma spouted from a certain one of the plasma generation nozzles 31 is pushed back by plasma spouted from the remaining plasma generation nozzles 31, within the narrow space 96.

As shown in FIGS. 1 and 4, the cover member 93 (93′) is formed and arranged to cover (wrap) the plasma generation nozzle 31. This makes it possible to prevent dusts or foreign particles from attaching on the cooling pipe 91, a gas pipe (not shown), an electric wire (not shown) or the electronic circuit board 361 which is laid around the plasma generation nozzle 31, and facilitate a cleaning operation therefor. This also makes it possible to suppress falling of dusts or foreign particles from the above component onto the workpiece W.

Although the workpiece processing apparatus S according to one embodiment of the present invention has been described, the present invention is not limited to the specific embodiment. For example, the embodiment may be modified as follows.

(1) In the above embodiment, the workpiece processing apparatus S is provided with only one plasma generation unit PU. Alternatively, the workpiece processing apparatus S is provided with a plurality of the plasma generation units PU.

(2) The above embodiment has been described based on one example where the carrying mechanism C for carrying a workpiece W is employed as carrying means, and the carrying mechanism C is configured to carry a workpiece W while placing it on top surfaces of the carrier rollers 80. Alternatively, the carrying mechanism C may be configured to carry a workpiece W while nipping it between upper and lower carrier rollers, or may be configured to receive a workpiece W in a predetermined container, such as a basket, and carry the container with the workpiece W by a line conveyer, without using the carrier rollers, or may be configured to carry a workpiece W to the plasma generation section 30 while holding it by a robot hand or the like. Alternatively, the carrying means may be configured to move the plasma generation nozzle 31. That is, a workpiece W and the plasma generation nozzles 31 may be relatively moved along a direction (X direction) intersecting a plasma emitting direction (Z direction) and a direction (Y direction) of the array of the plasma generation nozzles 31.

(3) In the above embodiment, the cover member 93 (93′) is formed in a box shape covering (wrapping) the plasma generation nozzle 31. Alternatively, if it is simply necessary to define the space 96 for retaining plasma, the cover member may be a flat plate attached to the distal end of the plasma generation nozzle 31.

(4) While the above embodiment has been described based on one example where the O-ring formed of a ring-shaped coil spring is employed as the resilient member 37, the resilient member 37 is not limited to the O-ring. For example, the resilient member 37 may be a so-called “D-ring”, “X-ring” or “C-ring” made of a metal material and formed in a D shape, an X shape or a C shape in section.

(5) In the above embodiment, the spring-type catch clip 212 is used for mounting the microwave generation device 20 to the top plate 11U of the first waveguide piece 11. Alternatively, a clip having no spring function may be used. In this case, a force for pressing the microwave generation device 20 against the top plate 11U may be generated by another member.

(6) In the above embodiment, the grip portion 351 of the holding member 35 is formed in a tubular shape. Alternatively, the grip portion 351 may be formed as a substantially solid portion having a columnar shape, and the center conductive member 32 may be embedded therein. In this case, a hole may be drilled from an outer peripheral surface of the columnar-shaped grip portion 351 to the upper end 321 of the center conductive member 32 so as to prevent melting of the grip portion 351.

### INDUSTRIAL APPLICABILITY

The workpiece processing apparatus and the plasma generator of the present invention can be suitably applied to an etching apparatus or a film-forming apparatus for a semiconductor substrate, such as a semiconductor wafer, a cleaning apparatus for a glass substrate or a printed substrate of a plasma display panel or the like, a sterilizing apparatus for a medical instrument or the like, and a protein-decomposing apparatus.

As above, the present invention can be summarized as follows.

A plasma generator of the present invention comprises a plasma generation nozzle adapted to spout a plasma from a spout port thereof; and a cover member having a continuous surface which is disposed around the spout port of the plasma generation nozzle, and formed to have an area greater than that of a distal end surface of the plasma generation nozzle.

That is, the present invention is directed to, in the first aspect, a plasma generator usable for a processing of a target object, such as a surface modification of a substrate, wherein the plasma generation nozzle is formed in a configuration suitable for plasma generation, for example, in a structure adapted to induce a glow discharge between inner and outer electrodes disposed in concentric relation to each other so as to generate a plasma, and supply a processing gas between the inner and outer electrodes so as to emit a plasmatized gas from a ring-shaped spout port, and wherein the plasma generation nozzle is provided with the cover member at a distal end thereof to suppress scattering of the plasma by the cover member. Specifically, the cover member is prepared by forming, in a plate-shaped member, an opening which allows the spout port of the plasma generation nozzle to be uncovered. Then, the cover member is attached to cover the plasma generation nozzle formed, for example, in a cylindrical shape, so that a continuous surface, such as a flat or curved continuous surface, having an area greater than that of the distal end surface of the plasma generation nozzle is provided around the spout port of the plasma generation nozzle.

Thus, a narrow space is defined between the cover member and the target object, and plasma spouted from the spout port can be retained in the space in such a manner as to hit against and rebound from the target object into the space. This makes it possible to subject a target object having a relatively large surface area to plasma exposure in a uniform manner, even using a low-cost, easily-controlled and small-diameter plasma generation nozzle having a spot-shaped spout port. In addition, the narrow space can suppress cooling of plasma to allow the plasma to survive for a relatively long period of time (reduce a plasma disappearance rate) so as to provide enhanced efficiency of plasma exposure.

Preferably, in the plasma generator of the present invention, the cover member is formed and arranged to cover the plasma generation nozzle.

According to this feature, the cover member can prevent scattering of dusts or foreign particles from a cooling pipe, an electric wire or an electronic circuit which is laid around the plasma generation nozzle.

Preferably, in the plasma generator of the present invention, when the plasma generation nozzle is provided in a plural number, the continuous surface of the cover member is formed and arranged to extend over respective distal end surfaces of the plural number of plasma generation nozzles.

According to this feature, the cover member is provided between respective adjacent ones of the plurality of plasma generation nozzles. Thus, plasma spouted from a certain one of the plasma generation nozzles is pushed back by plasma spouted from the remaining plasma generation nozzles, within the narrow space. This makes it possible to extend a retaining tine of the plasma in the narrow space so as to provide enhanced efficiency of plasma exposure.

Preferably, in the plasma generator of the present invention, the plasma generation nozzle includes an inner electrode, and an outer electrode constituting a nozzle body, wherein the inner and outer electrodes are disposed in concentric relation to each other to define the spout port therebetween with a ring shape when viewed in an axial direction of the plasma generation nozzle.

Preferably, the above plasma generator further comprises an adapter provided to a distal end of the plasma generation nozzle and communicated with the ring-shaped spout port to convert the ring-shaped spout port to a lengthwise spout port thereof.

Preferably, in the above plasma generator, the adapter includes: an attaching portion for connecting the adapter to a distal end portion of the nozzle body; a plasma chamber body provided to extend from a base end of the attaching portion in a horizontal direction and define an opening which is communicated with the ring-shaped spout port and provided to extend in the horizontal direction; and a slit plate connected to the plasma chamber body, and formed with an opening which converts the ring-shaped spout port to the lengthwise spout port in cooperation with the opening of the plasma chamber body. According to this feature, although the spout port of the plasma generation nozzle itself is designed to produce a spot-shaped plasma stream, the spot-shaped plasma stream can be converted to a line-shaped plasma stream through the adapters, and then the line-shaped plasma stream can be further converted to a planar-shaped plasma stream through the cover member. Thus, as compared with a plasma generator adapted to convert the spot-shaped plasma stream from the cylindrical-shaped plasma generation nozzle, directly to the planar-shaped plasma stream through the cover member, the plasma generator additionally provided with the adapter can more effectively suppress cooling of plasma and increase the retaining time of the plasma so as to provide more enhanced efficiency of plasma exposure.

Preferably, in the above plasma generator, the inner electrode consists of a center conductive member which is provided to extend in an upward/downward direction, and adapted to induce a glow discharge in cooperation with the outer electrode so as to generate a plasma.

Preferably, the above plasma generator further comprises a waveguide disposed above the plasma generation nozzle and adapted to propagate a microwave, wherein the center conductive member has an upper end disposed inside the waveguide, and a lower end disposed approximately at a same position as that of a lower end surface of the nozzle body.

Preferably, the above plasma generator further comprises: a holding member which holds the center conductive member at a predetermined position within the waveguide, wherein the holding member has an upper end which protrudes upwardly from an opening formed in an upper surface of the waveguide; and a cap member which covers the protruding end from above.

Preferably, in the above plasma generator, the holding member is formed in a cylindrical shape, wherein the nozzle body has an upper surface formed to define a receiving space which receives therein a lower end of the holding member, and the cap member is formed to define a receiving space which receives therein the upper end of the holding member, whereby the holding member is retained in such a manner as to penetrate through the waveguide in the upward/downward direction.

According to this feature, the center conductive member serving as the inner electrode can be constantly set at a predetermined position to allow a glow discharge to be stably induced.

Preferably, in the plasma generator of the present invention, the cover member is formed and arranged to allow a lower end of the plasma chamber body to be uncovered thereby.

Preferably, in the above plasma generator, the continuous surface has an outer peripheral edge which rises in a spouting direction of the plasma.

According to this feature, the outer peripheral edge of the continuous surface rising in the spouting direction of the plasma can more effectively suppress scattering of the plasma.

The present invention also provides a workpiece processing apparatus which comprises the aforementioned plasma generator, and carrying means adapted to carry a workpiece to the plasma generator in a predetermined carrying direction.

The workpiece processing apparatus using the aforementioned plasma generator can subject a target object (i.e., workpiece) having a relatively large surface area to plasma exposure in a uniform manner, even using a low-cost, easily-controlled and small-diameter plasma generation nozzle having a spot-shaped spout port.

Preferably, the workpiece processing apparatus of the present invention, the continuous surface of the cover member is disposed in approximately parallel relation to a surface of the workpiece.

According to this feature, the cover member is formed in a given shape, such as a flat shape or a curved shape, in conformity to a shape of a surface of the workpiece. This makes it possible to evenly define a gap between the cover member and the surface of the workpiece, in the narrow space, so as to subject the surface of the workpiece to plasma exposure in a uniform manner.

The present invention further provides a workpiece processing apparatus which comprises the aforementioned plasma generator, and carrying means adapted to carry a workpiece to the plasma generator in a predetermined carrying direction.

As above, according to the present invention, in a plasma generator usable for a processing of a target object, such as a surface modification of a substrate, a cover member is provided to a distal end of a plasma generation nozzle to allow a narrow space to be defined between the cover member and the target object, so that plasma spouted from the spout port is retained in the space in such a manner as to hit against and rebound from the target object into the space.

This makes it possible to subject a target object having a relatively large surface area to plasma exposure in a uniform manner, even using a low-cost, easily-controlled and small-diameter plasma generation nozzle having a spot-shaped spout port. In addition, the narrow space can suppress cooling of plasma to allow the plasma to survive for a relatively long period of time (reduce a plasma disappearance rate) so as to provide enhanced efficiency of plasma exposure.

This application is based on Japanese Patent Application Serial No. 2007-146856, filed in Japan Patent Office on Jun. 1, 2007, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A plasma generator comprising:
a plasma generation nozzle adapted to spout a plasma from a spout port thereof; and
a cover member having a continuous surface which is disposed around said spout port of said plasma generation nozzle, and formed to have an area greater than that of a distal end surface of said plasma generation nozzle.

2. The plasma generator according to claim 1, wherein said cover member is formed and arranged to cover said plasma generation nozzle.

3. The plasma generator according to claim 1, wherein said plasma generation nozzle is provided in a plural number, wherein said continuous surface of said cover member is formed and arranged to extend over respective distal end surfaces of said plural number of plasma generation nozzles.

4. The plasma generator according to claim 1, wherein said plasma generation nozzle includes an inner electrode, and an outer electrode constituting a nozzle body, said inner and outer electrodes being disposed in concentric relation to each other to define said spout port therebetween with a ring shape when viewed in an axial direction of said plasma generation nozzle.

5. The plasma generator according to claim 4, further comprising an adapter provided to a distal end of said plasma generation nozzle and communicated with said ring-shaped spout port to convert said ring-shaped spout port to a lengthwise spout port thereof in a horizontal direction.

6. The plasma generator according to claim 5, wherein said adapter including:
an attaching portion for connecting said adapter to a distal end portion of said nozzle body;
a plasma chamber body provided to extend from a base end of said attaching portion in a horizontal direction and define an opening which is communicated with said ring-shaped spout port and provided to extend in said horizontal direction; and
a slit plate connected to said plasma chamber body, and formed with an opening which converts said ring-shaped spout port to said lengthwise spout port in cooperation with said opening of said plasma chamber body.

7. The plasma generator according to claim 4, wherein said inner electrode including a center conductive member which is provided to extend in an upward/downward direction, and adapted to induce a glow discharge in cooperation with said outer electrode so as to generate a plasma.

8. The plasma generator according to claim 7, further comprising a waveguide disposed above said plasma generation nozzle and adapted to propagate a microwave, wherein said center conductive member has an upper end disposed inside said waveguide, and a lower end disposed approximately at a same position as that of a lower end surface of said nozzle body.

9. The plasma generator according to claim 8, further comprising:
a holding member which holds said center conductive member at a predetermined position within said waveguide, said holding member having an upper end which protrudes upwardly from an opening formed in an upper surface of said waveguide; and
a cap member which covers said protruding end from above.

10. The plasma generator according to claim 9, wherein said holding member is formed in a cylindrical shape, said nozzle body has an upper surface formed to define a receiving space which receives therein a lower end of said holding member, and said cap member is formed to define a receiving space which receives therein the upper end of said holding member, whereby said holding member is retained in such a manner as to penetrate through said waveguide in the upward/downward direction.

11. The plasma generator according to claim 1, wherein said cover member is formed and arranged to allow a lower end of said plasma chamber body to be uncovered thereby.

12. The plasma generator according to claim 11, wherein said continuous surface has an outer peripheral edge which rises in a spouting direction of the plasma.

13. A workpiece processing apparatus comprising:
a) a plasma generator including:
a1) a plasma generation nozzle adapted to spout a plasma from a spout port thereof, and
a2) a cover member having a continuous surface which is disposed around said spout port of said plasma generation nozzle, and formed to have an area greater than that of a distal end surface of said plasma generation nozzle; and
b) carrying means adapted to carry a workpiece to said plasma generator in a predetermined carrying direction.

14. The workpiece processing apparatus according to claim 13, wherein said continuous surface of said cover member is disposed in approximately parallel relation to a surface of said workpiece.

15. A workpiece processing apparatus comprising:
a) a plasma generator including:
a1) a plurality of plasma generation nozzles each adapted to spout a plasma from a spout port thereof, said plasma generation nozzles being disposed at even intervals in a first horizontal direction, and
a2) a cover member having a continuous surface which is disposed around said respective spout ports of said plurality of plasma generation nozzles, and formed to have an area greater than that of respective distal end surfaces of said plasma generation nozzles; and
b) carrying means adapted to carry a workpiece to said plasma generator in a second horizontal direction orthogonal to said first horizontal direction.
